(19) United States
(12) Patent Application Publication
(10) Pub. No.: US 2021/0368668 A1
(43) Pub. Date: Dec. 2, 2021

(54) AGRICULTURAL IMPLEMENT HAVING A WING WHEEL LINKAGE ASSEMBLY

(71) Applicant: CNH Industrial America LLC, New Holland, PA (US)

(72) Inventors: Monte DeKam, Westmont, IL (US); Kregg J. Raducha, Chicago, IL (US); Austin Joseph McLuckie, Coal City, IL (US)

(21) Appl. No.: 17/320,889

(22) Filed: May 14, 2021

Related U.S. Application Data
(60) Provisional application No. 63/005,989, filed on Apr. 6, 2020.

(51) Int. Cl. A01B 63/00; A01B 63/22

(52) U.S. Cl. CPC A01B 63/008; A01C 7/08; A01B 63/22

(57) ABSTRACT

An agricultural implement includes a main frame assembly, a toolbar coupled to the main frame assembly, and a wing wheel linkage assembly coupled to the toolbar. The agricultural implement also includes a wing wheel rotatably coupled to the wing wheel linkage assembly. In addition, the agricultural implement includes an actuator coupled to the wing wheel linkage assembly and configured to drive the wing wheel linkage assembly to move the wing wheel linkage assembly substantially along a vertical axis between a planting position and a headland position.

### BACKGROUND

The disclosure relates generally to an agricultural implement having a wing wheel linkage assembly.

Generally, planting implements (e.g., planters) are towed behind a tractor or other work vehicle via a hitch assembly. These planting implements typically include multiple row units distributed across the width of the implement. Each row unit is configured to deposit seeds at a target depth beneath the soil surface, thereby establishing rows of planted seeds. For example, each row unit may include a ground engaging tool or opener (e.g., an opener disc) that forms a seeding path (e.g., trench) for seed deposition into the soil. In certain configurations, a gauge wheel is positioned a vertical distance above the opener to establish a target trench depth for seed deposition into the soil. As the implement travels across a field, the opener excavates a trench into the soil, and seeds are deposited into the trench via a seed tube positioned behind the opener. In certain row units, the opener is followed by a packer wheel that packs the soil on top of the deposited seeds.

Certain planting implements include a main frame assembly coupled to the hitch assembly, and main wheels coupled to the main frame assembly and configured to support the main frame assembly. Furthermore, a toolbar is coupled to the main frame assembly and configured to support the row units. In certain configurations, the planting implement includes one or more support wheels (e.g., wing wheels) coupled to the toolbar (e.g., proximate to ends of the toolbar) to support the toolbar at least while the implement is engaged in planting operations. Unfortunately, due to the configuration and/or position of the support wheels, the support wheels may not effectively track the path of the planting implement (e.g., at least while the toolbar is in a raised position), thereby smearing the soil surface. As a result, the yield from seeds planted within the path of the support wheels may be reduced.

### BRIEF DESCRIPTION

In certain embodiments, an agricultural implement includes a main frame assembly, a toolbar coupled to the main frame assembly, and a wing wheel linkage assembly coupled to the toolbar. The agricultural implement also includes a wing wheel rotatably coupled to the wing wheel linkage assembly. In addition, the agricultural implement includes an actuator coupled to the wing wheel linkage assembly and configured to drive the wing wheel linkage assembly to move the wing wheel linkage assembly substantially along a vertical axis between a planting position and a headland position. The wing wheel linkage assembly is configured to control movement of the wing wheel along a longitudinal axis of the agricultural implement as the wing wheel moves between the planting position and the headland position, such that a rotational axis of the wing wheel is substantially aligned with an alignment line while the wing wheel is in the planting position and while the wing wheel is in the headland position. The alignment line extends through a pivot axis of the agricultural implement and extends parallel to a lateral axis of the agricultural implement.

### DRAWINGS

These and other features, aspects, and advantages of the present disclosure wheel become better understood when the following detailed description is read with reference to the accompanying drawings in which like characters represent like parts throughout the drawings, wherein:

FIG. 1 is a perspective view of an embodiment of an agricultural implement having a toolbar in a working position and wing wheel linkage assemblies in a planting position, in accordance with an embodiment of the present disclosure;

FIG. 2 is a top view of the agricultural implement of FIG. 1, in which the toolbar is in the working position and the wing wheel linkage assemblies are in the planting position;

FIG. 3 is a perspective view of the agricultural implement of FIG. 1, in which the toolbar is in a raised position and the wing wheel linkage assemblies are in a headland position;

FIG. 4 is a top view of the agricultural implement of FIG. 1, in which the toolbar is in the raised position and the wing wheel linkage assemblies are in the headland position; and

FIG. 5 is a perspective view of a wing wheel linkage assembly of the agricultural implement of FIG. 1, in which the wing wheel linkage assembly is in the headland position.

### DETAILED DESCRIPTION

One or more specific embodiments of the present disclosure wheel be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Traditionally, to transition an agricultural implement (e.g., planting implement) between different configurations (e.g., from a working configuration to a headland configuration), wing wheels of the agricultural implement are moved (e.g., downwardly) along a vertical axis relative to a toolbar of the agricultural implement. For example, the wing wheels may be movably coupled to the toolbar by respective parallel linkage assemblies. Accordingly, as each wing wheel is moved (e.g., downwardly) along the vertical axis, the respective parallel linkage assembly causes the wing wheel to move in a horizontal direction (e.g., along a longitudinal axis of the agricultural implement). The horizontal movement (e.g., movement in the fore/aft direction) of the wing wheels may cause the wing wheels to become significantly longitudinally offset (e.g., misaligned) from a pivot axis (e.g., axis of rotation) of the agricultural implement. Such an offset may cause the wing wheels to drag sideways while the agricultural implement is turning. As a result, the wing wheels may smear the soil surface, thereby reducing yield from seeds planted within the path of the wing wheels.

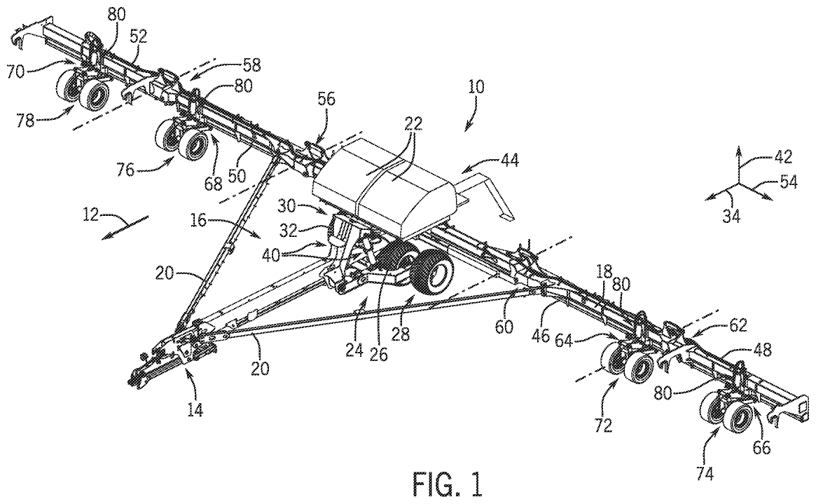

FIG. 1 is a perspective view of an embodiment of an agricultural implement (e.g., planting implement), in which a toolbar of the agricultural implement is in a working (e.g., planting) position and wing wheel linkage assemblies are in a planting position. While the toolbar is in the illustrated working position, row units coupled to the toolbar engage the soil. In the illustrated embodiment, an agricultural implement 10 is configured to be towed along a direction of travel 12 by a work vehicle, such as a tractor or other prime mover. The work vehicle may be coupled to the agricultural implement 10 by a hitch assembly 14. As illustrated, the hitch assembly 14 is coupled to a main frame assembly 16 of the agricultural implement 10 to facilitate towing of the agricultural implement 10 in the direction of travel 12.

In the illustrated embodiment, the main frame assembly 16 is coupled to a toolbar 18. In certain embodiments, the main frame assembly 16 is coupled to the toolbar 18 via linking assemblies 20 that extend from a toolbar 18 and to the main frame assembly 16 proximate to the hitch assembly 14. The toolbar 18 may include multiple mounts for supporting multiple row units. Each row unit may be configured to deposit seeds at a target depth beneath the soil surface, thereby establishing rows of planted seeds. The agricultural implement 10 also includes seed tanks 22. Seeds from the seed tanks 22 may be transported to the row units via a pneumatic distribution system. In certain embodiments, the pneumatic distribution system includes an inductor box positioned beneath each seed tank 22. Each inductor box is configured to receive seeds from a respective tank, to fluidize the seeds into an air/seed mixture, and to distribute the air/seed mixture to the row units via a network of pneumatic hoses/conduits. While the illustrated agricultural implement 10 includes two seed tanks 22, in alternative embodiments, the agricultural implement may include more or fewer seed tanks, such as 1, 2, 3, 4, 5, 6, or more seed tanks.

In certain embodiments, each row unit coupled to the toolbar 18 may include a residue manager, an opening assembly, a seed tube, closing discs, and a press wheel. The residue manager includes a rotating wheel having multiple tillage points or fingers that break up crop residue, thereby preparing the soil for seed deposition. The opening assembly includes a gauge wheel and an opener disc. The gauge wheel may be positioned a vertical distance above the opener disc to establish a target trench depth for seed deposition into the soil. As the row unit travels across a field, the opener disc excavates a trench into the soil for seed deposition. The seed tube, which may be positioned behind the opening assembly, directs a seed from a metering system into the excavated trench. The closing discs then direct the excavated soil into the trench to cover the planted seed. Finally, the press wheel packs the soil on top of the seed with a target pressure.

In the illustrated embodiment, the agricultural implement 10 includes main wheel assemblies 24. The main wheel assemblies include a first left main wheel assembly 26, a second left main wheel assembly 28, a first right main wheel assembly 30, and a second right wheel assembly 32. The first left main wheel assembly 26 and the first right main wheel assembly 30 may be positioned closer to a lateral midpoint of the agricultural implement 10 along a lateral axis 54 than the second left main wheel assembly 28 and the second right main wheel assembly 32, respectively. In other words, the second left main wheel assembly 28 and the second right main wheel assembly 32 are positioned laterally outward from the first left main wheel assembly 26 and the first right main wheel assembly 30, respectively, along the lateral axis 54.

Further, the first left main wheel assembly 26 is positioned forward of the second left main wheel assembly 28 along a longitudinal axis 34, which is parallel to the direction of travel 12. Similarly, the first right main wheel assembly 30 is positioned forward of the second right main wheel assembly 32 along the longitudinal axis 34. The rotational axis of the first left main wheel assembly 26 and the first right main wheel assembly 30 is longitudinally offset from the rotational axis of the second left main wheel assembly 28 and the second right main wheel assembly 32. Indeed, in the illustrated embodiment, a finite distance along the longitudinal axis 34 is present between the rotational axes of the first left main wheel assembly 26 and the second left main wheel assembly 28. A finite distance along the longitudinal axis 34 is also present between the rotational axes of the first right main wheel assembly 30 and the second right main wheel assembly 32. Each main wheel assembly 24 is coupled to the main frame assembly 16, and each main wheel assembly 24 is configured to support the main frame assembly 16 above the soil surface. A first pivot assembly is coupled to the right main wheel assemblies, and a second pivot assembly is coupled to the left main wheel assemblies. Each pivot assembly enables the respective main wheel assemblies to move along a vertical axis 42 relative to the main frame assembly 16, thereby enabling the main wheel assemblies to follow the contours of a field as the agricultural implement 10 traverses the field along the direction of travel 12. In some embodiments, instead of main wheel assemblies 24, track assemblies (e.g., one left track assembly and one right track assembly) may support the main frame assembly 16 above the soil surface.

In the illustrated embodiment, the main wheel assemblies 24 are movably coupled to the main frame assembly 16 via a linkage assembly 38. The linkage assembly 38 enables the main wheel assemblies 24 to move along a vertical axis 42 to transition the agricultural implement 10 between configurations (e.g., the working configuration and the headland configuration). For example, downward movement of the main wheel assemblies 24 relative to the main frame assembly 16 causes the toolbar 18 to move from the illustrated working position to a raised position (or another position/configuration). In the illustrated embodiment, the linkage assembly 38 is a pivot assembly. However, in other embodiments, the linkage assembly 38 may be another suitable type of linkage assembly.

As illustrated, two actuators 40 (e.g., hydraulic cylinders, etc.) extends between the main frame assembly 16 and the linkage assembly 38, which is connected to the main wheel assemblies 24. The actuators 40 are configured to drive the main wheel assemblies 24 between a working (e.g., planting) position, a headland position, and a transport position. While the two actuators 40 are coupled to the linkage assembly 38 in the illustrated embodiment, in other embodiments, more or fewer actuators (e.g., 0, 1, 2, 3, 4, or more) may be coupled to the linkage assembly 38. While the illustrated agricultural implement 10 includes a single linkage assembly 38, in other embodiments, the agricultural implement 10 may include more or fewer linkage assemblies (e.g., 1, 2, 3, 4, or more). Furthermore, as illustrated, the position of the toolbar 18 is fixed relative to the main frame assembly 16. The vertical position of the toolbar 18 (e.g., position along the vertical axis 42) is controlled at least in part by adjusting the position of the main frame assembly 16 relative to the main wheel assemblies 24 (e.g., via the actuators 40 that extend between the linkage assembly 38 and the main frame assembly 16).

In the illustrated embodiment, the toolbar 18 has a center section 44, a first left wing section 46, a second left wing section 48, a first right wing section 50, and a second right wing section 52. The first left wing section 46 and the first right wing section 50 are positioned on opposite sides of the center section 44 along the lateral axis 54. Similarly, the second left wing section 48 and the second right wing section 52 are positioned on opposite sides of the center section 44 along the lateral axis 54.

As illustrated, the first right wing section 50 is pivotally coupled to the center section 44 by a first right wing joint 56, and the second right wing section 52 is pivotally coupled to the first right wing section 50 by a second right wing joint 58. Likewise, the first left wing section 46 is pivotally coupled to the center section 44 by a first left wing joint 60, and the second left wing section 48 is pivotally coupled to the first left wing section 46 by a second left wing joint 62. The first left wing joint 60 and the first right wing joint 56 are closer to a midpoint of the toolbar 18 along the lateral axis 54 than the second left wing joint 62 and the second right wing joint 58. The first right wing section 50 may rotate about an axis parallel to the longitudinal axis 34 (e.g., in response to being driven by an actuator), and the second right wing section 52 may rotate about an axis parallel to the longitudinal axis 34 (e.g., in response to being driven by an actuator).

In addition, the first left wing section 46 may rotate about an axis parallel to the longitudinal axis 34 (e.g., in response to being driven by an actuator), and the second left wing section 48 may rotate about an axis parallel to the longitudinal axis 34 (e.g., in response to being driven by an actuator). In certain embodiments, each wing joint is configured to block rotation of the respective wing section about an axis parallel to the lateral axis 54 and about an axis parallel to the vertical axis 42.

In the illustrated embodiment, the agricultural implement 10 includes wing wheel linkage assemblies coupled to the toolbar 18. As illustrated, the agricultural implement 10 includes a first left wing wheel linkage assembly 64 coupled to the first left wing section 46 of the toolbar 18, a second left wing wheel linkage assembly 66 coupled to the second left wing section 48 of the toolbar 18, a first right wing wheel linkage assembly 68 coupled to the first right wing section 50 of the toolbar 18, and a second right wing wheel linkage assembly 70 coupled to the second right wing section 52 of the toolbar 18. In the illustrated embodiment, two wing wheels (i.e., wing wheels 72, 74, 76, 78) are coupled to each respective wing wheel linkage assembly. The wing wheel linkage assemblies enable the respective wing wheels to move substantially along the vertical axis 42 as the wing wheels transition between different positions/configurations (e.g., a planting position and a headland position, etc.). Also, the wing wheel linkage assemblies may block the respective wing wheels from rotation about the vertical axis 42. As discussed in detail below, each wing wheel linkage assembly is configured to substantially reduce an amount of horizontal motion of the respective wheel wings as the respective wing wheels move between the planting position and the headland position (e.g., as compared to wing wheels that are coupled to the toolbar via a parallel linkage). As a result, the wing wheels may be maintained in a longitudinal position longitudinally proximate to the pivot axis (e.g., axis of rotation) of the agricultural implement 10 while the wing wheels are in the planting position and in the headland position, thereby substantially aligning the wing wheels with the direction of motion of the toolbar 18 as the agricultural implement turns. Accordingly, smearing of the soil by the wing wheels may be substantially reduced, thereby enhancing yield from seeds planted within the path of the wing wheels.

In the illustrated embodiment, each wing wheel linkage assembly is coupled to a respective actuator 80. The actuators 80 are configured to drive the wing wheel linkage assemblies to move the respective wing wheels relative to the toolbar 18. For example, each actuator may drive a respective wing wheel linkage assembly to move a respective wing wheel pair substantially along the vertical axis 42. While a single actuator is coupled to each wing wheel assembly in the illustrated embodiment, in some embodiments, more than one actuator may be coupled to at least one wing wheel linkage assembly.

While two wing wheel linkage assemblies are coupled to each lateral side of the toolbar 18 in the illustrated embodiment, in other embodiments, more or fewer wing wheel linkage assemblies (e.g., 0, 1, 2, 3, 4, or more) may be coupled to each lateral side of the toolbar 18. For example, in certain embodiments, one wing wheel linkage assembly may be coupled to each outer wing section, and no wing wheel linkage assembly may be coupled to each inner wing section. In addition, while the illustrated toolbar (i.e. the toolbar 18) includes two left wing sections and two right wing sections, in other embodiments, the toolbar 18 may include more or fewer wing sections (e.g., 0, 1, 2, 3, 4, or more) on each lateral side of the center section 44.

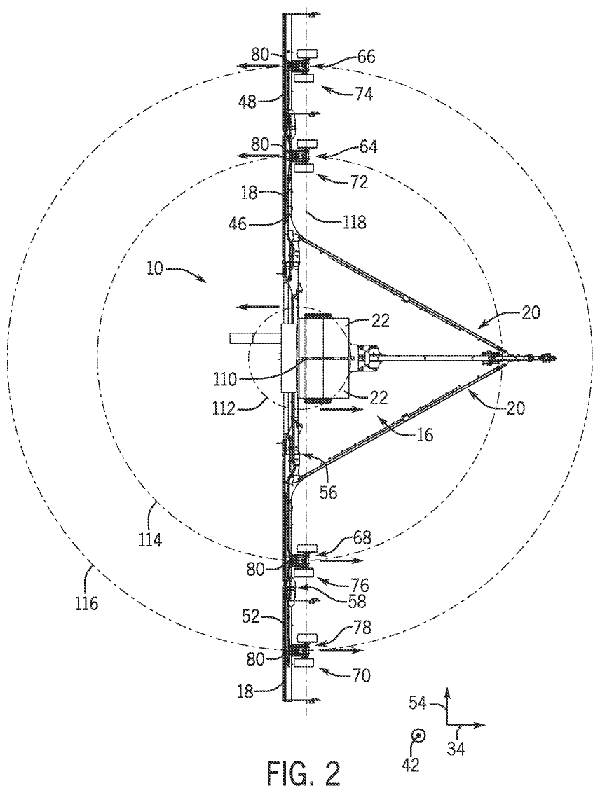

FIG. 2 is a top view of the agricultural implement 10 of FIG. 1, in which the toolbar is in the working position and the wing wheel linkage assemblies are in the planting position. As shown in FIG. 2, the agricultural implement 10 is configured to rotate around a pivot axis 110 (e.g., axis of rotation) that is located in between the main wheel assemblies (e.g., while the agricultural implement is following a curved swath through the field). In certain embodiments, the pivot axis 110 is positioned between the inner main wheel assembly along the lateral axis 54 (e.g., at the lateral center point of the agricultural implement 10). In addition, the pivot axis 110 may be positioned between the rotational axis of the inner main wheels and the rotational axis of the outer main wheels along the longitudinal axis 34.

FIG. 2 shows concentric circles, which represent the paths of the wheels of the main wheel assemblies 24 and of the wing wheels pairs of the agricultural implement 10 about the pivot axis 110. A first circular path 112 represents a general path of the wheels of the main wheel assemblies 24 about the pivot axis 110. For example, the first circular path 112 may extend between the inner wheels and the outer wheels of the main wheel assemblies 24. A second circular path 114 represents a general path of the wing wheels 72, which are coupled to the first left wing wheel linkage assembly 64, and a general path of the wing wheels 76, which are coupled to the first right wing wheel linkage assembly 68. A third circular path 116 represents a general path of the wing wheels 74, wherein are coupled to the second left wing wheel linkage assembly 66, and a path of the wing wheels 78, which are coupled to the second right wing wheel linkage assembly 70. For example, the second and third circular paths may extend between the inner wheels and the outer wheels of each wing wheel linkage assembly. As illustrated, the first circular path 112 has a radius that is smaller than both the radius of the second circular path 114 and the radius of the third circular path 116. The radius of the second circular path 114 is greater than the radius of the first circular path 112 and less than the radius of the third circular path 116. In some embodiments, more or fewer wing wheels and/or main wheels may follow respective circular paths.

With the wing wheel linkage assemblies in the illustrated planting position, the rotational axes of the wing wheels are substantially aligned with an alignment line 118, which extends through the pivot axis 110 and is parallel to the lateral axis 54 (e.g., perpendicular to the direction of travel). As used herein, “substantially aligned” refers to an offset between the rotational axis of a respective wing wheel and the alignment line 118 along the longitudinal axis 34 of less than a threshold value. In certain embodiments, the threshold value may be between 1 cm and 100 cm, between 1 cm and 50 cm, between 1 cm and 20 cm, or between 1 cm and 10 cm. By way of further example, the threshold value may be 1 cm, 10 cm, 17 cm, 24 cm, 30 cm, 50 cm, 75 cm, 90 cm, or 100 cm. Moreover, the pivot axis 110 translates relative to the field along the direction of travel 12 as the agricultural implement 10 is towed through the field. As such, the wing wheel pairs and the main wheel assemblies 24 rotate about the pivot axis 110 and translate along the direction of travel of the agricultural implement 10. Accordingly, during a turn, the wing wheel pairs move along the direction of travel and about the pivot axis 110. Due to the substantial alignment between the rotational axis of each wing wheel and the alignment line 118, the wing wheels may be substantially aligned with the direction of motion of the toolbar 18 (e.g., at the respective wing wheels) as the agricultural implement 10 turns. Accordingly, smearing of the soil by the wing wheels may be substantially reduced, thereby enhancing yield from seeds planted within the path of the wing wheels.

As discussed in detail below, the wing wheel linkage assemblies enable the wing wheels to move along the vertical axis 42 between the illustrated planting position and the headland position while substantially reducing movement of the wing wheel along the longitudinal axis. As a result, the substantial alignment of the wing wheels with the alignment line 118 may be preserved while the wing wheels are in the planting position. Indeed, as a result, smearing of the soil by the wing wheels may be substantially reduced as the agricultural implement turns at a headland, thereby enhancing yield from seeds planted within the path of the wing wheels.

In the illustrated embodiment, a first wheel of each pair of wing wheels has a rotational axis that is positioned forward of the rotational axis of a second wheel of the respective pair of wing wheels. A pivot assembly is coupled to each pair of wing wheels. Each pivot assembly enables the respective pair of wing wheels to move along the vertical axis 42 relative to the toolbar 18. As previously discussed, the rotational axis of each wing wheel is substantially aligned with the alignment line 118. While a pair of wing wheels are coupled to each wing wheel linkage assembly in the illustrated embodiment, in other embodiments, more or fewer wheels (e.g., 1, 2, 3, 4, 5, 6, etc.) may be coupled to at least one wing wheel linkage assembly.

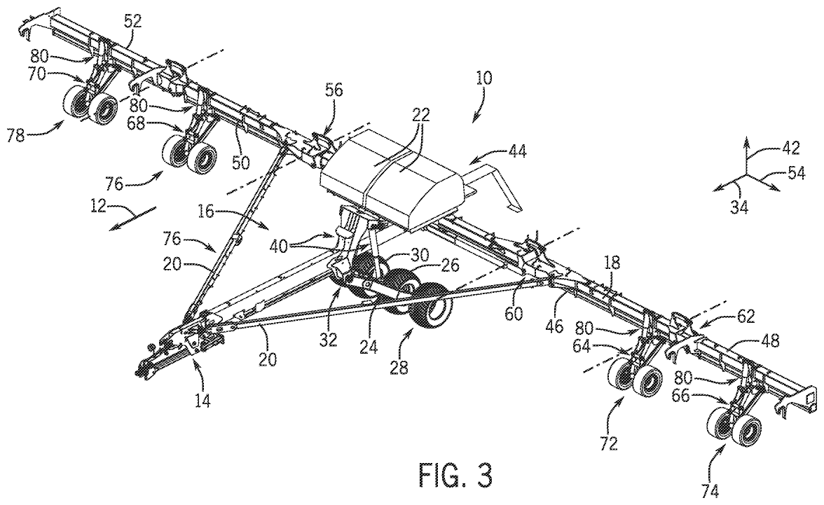

FIG. 3 is a perspective view of the agricultural implement 10 of FIG. 1, in which the toolbar is in a raised position and the wing wheel linkage assemblies are in a headland position. At an end of a swath within the field, the agricultural implement 10 may transition to a headland configuration. While the agricultural implement 10 is in the headland configuration, the toolbar 18 is in the raised position (e.g., in which the toolbar 18 is positioned above the working position along the vertical axis 42) and the wing wheel linkage assemblies are in the headland position. With the agricultural implement 10 in the headland configuration, the row units are disengaged from the soil, thereby enabling the agricultural implement 10 to turn at a headland. With the toolbar 18 in the raised position, the toolbar 18 is positioned above the position of the toolbar 18 in FIG. 1. The toolbar 18 is transitioned to the raised position at least in part by the expansion of each wing wheel linkage assembly. As discussed in detail below, an actuator 80 coupled to the first left wing wheel assembly 64 may drive the first left wing wheel linkage assembly 64 to expand, thereby transitioning the first left wing wheel linkage assembly 64 from the planting position to the headland position. Expansion of the first left wing wheel linkage assembly 64 drives the respective wing wheels 72 to move downwardly relative to the toolbar 18. The relative downward motion of the wing wheels 72 causes the toolbar 18 to rise along the vertical axis 42. Further, because the wing wheels 72 move substantially along the vertical axis 42, a position of the axes of rotation of the wing wheels 72 along the longitudinal axis 34 is substantially maintained. Also, the main wheels of the main wheel assemblies 24 are moved downwardly relative to the main frame assembly 16, thereby raising the main frame assembly 16 upwardly relative to the soil surface. Because the wing wheels of each wing wheel linkage assembly move substantially along the vertical axis 42 from the planting configuration to the illustrated headland configuration, alignment of the wing wheels with the direction of motion of the toolbar 18 may be substantially maintained. Accordingly, smearing of the soil by the wing wheels may be substantially reduced, thereby enhancing yield from seeds planted within the path of the wing wheels.

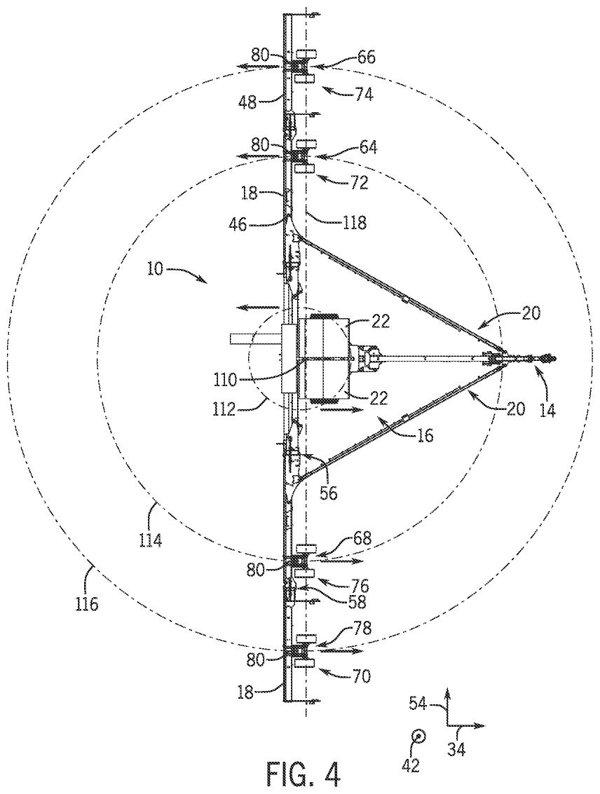

FIG. 4 is a top view of the agricultural implement 10 of FIG. 1, in which the toolbar is in the raised position and the wing wheel linkage assemblies are in the headland position. As noted above, the agricultural implement 10 may transition the headland configuration when performing an end of row (e.g., headland) turn.

FIG. 4 shows concentric circles, which represent paths of the wheels of the main wheel assemblies 24 and of the wing wheels pairs during a rotation of the agricultural implement 10 about the pivot axis 110. A first circular path 112 represents a general path of the wheels of the main wheel assemblies 24 about the pivot axis 110. For example, the first circular path 112 may extend between the inner wheels and the outer wheels of the main wheel assemblies. A second circular path 114 represents a general path of the wing wheels 72, which are coupled to the first left wing wheel linkage assembly 64, and a general path of the wing wheels 76, which are coupled to the first right wing wheel linkage assembly 68. A third circular path 116 represents a general path of the wing wheels 74, wherein are coupled to the second left wing wheel linkage assembly 66, and a path of the wing wheels 78, which are coupled to the second right wing wheel linkage assembly 70. For example, the second and third circular paths may extend between the inner wheels and the outer wheels of each wing wheel linkage assembly. As illustrated, the first circular path 112 has a radius that is smaller than both the radius of the second circular path 114 and the radius of the third circular path 116. The radius of the second circular path 114 is greater than the radius of the first circular path 112 and less than the radius of the third circular path 116. In some embodiments, more or fewer wing wheels and/or main wheels may follow respective circular paths.

With the wing wheel linkage assemblies in the illustrated headland position, the rotational axes of the wing wheels are substantially aligned with an alignment line 118, which extends through the pivot axis 110 and is parallel to the lateral axis 54 (e.g., perpendicular to the direction of travel). As used herein, “substantially aligned” refers to an offset between the rotational axis of a respective wing wheel and the alignment line 118 along the longitudinal axis 34 of less than a threshold value. In certain embodiments, the threshold value may be between 1 cm and 100 cm, between 1 cm and 50 cm, between 1 cm and 20 cm, or between 1 cm and 10 cm. By way of further example, the threshold value may be 1 cm, 10 cm, 17 cm, 24 cm, 30 cm, 50 cm, 75 cm, 90 cm, or 100 cm. Moreover, the pivot axis 110 translates relative to the field along the direction of travel 12 as the agricultural implement 10 is towed through the field. As such, the wing wheel pairs and the main wheel assemblies 24 rotate about the pivot axis 110 and translate along the direction of travel of the agricultural implement 10. Accordingly, during a turn, the wing wheel pairs move along the direction of travel and about the pivot axis 110. Due to the substantial alignment between the rotational axis of each wing wheel and the alignment line 118, the wing wheels may be substantially aligned with the direction of motion of the toolbar 18 (e.g., at the respective wing wheels) as the agricultural implement 10 turns. Accordingly, smearing of the soil by the wing wheels may be substantially reduced, thereby enhancing yield from seeds planted within the path of the wing wheels.

As discussed in detail below, the wing wheel linkage assemblies enable the wing wheels to move along the vertical axis 42 (relative to the toolbar 18) between the illustrated headland position and the planting position while substantially reducing movement of the wing wheel along the longitudinal axis. As a result, the substantial alignment of the wing wheels with the alignment line 118 may be preserved while the wing wheels are in the headland position. Indeed, as a result, smearing of the soil by the wing wheels may be substantially reduced as the agricultural implement turns at a headland, thereby enhancing yield from seeds planted within the path of the wing wheels.

In the illustrated embodiment, a first wheel of each pair of wing wheels has a rotational axis that is positioned forward of the rotational axis of a second wheel of the respective pair of wing wheels. As previously discussed, the rotational axis of each wing wheel is substantially aligned with the alignment line 118. While a pair of wing wheels are coupled to each wing wheel linkage assembly in the illustrated embodiment, in other embodiments, more or fewer wheels (e.g., 1, 2, 3, 4, 5, 6, etc.) may be coupled to at least one wing wheel linkage assembly.

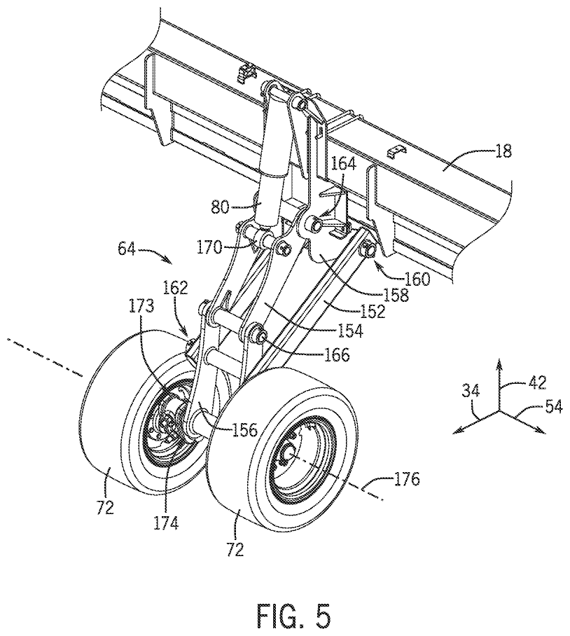

FIG. 5 is a perspective view of a wing wheel linkage assembly of the agricultural implement 10 of FIG. 1, in which the wing wheel linkage assembly is in the headland position. The first wing wheel linkage assembly 64 (e.g., an asymmetric four bar linkage) includes a first link 152, a second link 154, a third link 156, and a toolbar link 158. The first link 152 is pivotally coupled to the toolbar link 158 at a first joint 160, and the toolbar link 158 is rigidly coupled to the toolbar 18. The first link 152 is also pivotally coupled to the third link 156 at a second joint 162. The second link 154 is pivotally coupled to the toolbar link 158 at a third joint 164, and the second link 154 is pivotally coupled to the third link 156 at a fourth joint 166. The second link 154 is coupled, at a fifth joint 170, to an actuator 80 (e.g., a hydraulic cylinder) that drives the wing wheel linkage assembly 64 to move the wing wheels 72 along the vertical axis 42. The third link 156 is pivotally coupled to a pivot assembly 173 via a sixth joint 174. In the illustrated embodiment, the first link 152 is longer than the second link 154.

In the illustrated embodiment, the third link 156 is pivotally coupled to the first link 152 at the second joint 162, pivotally coupled to the second link 154 at the fourth joint 166, and pivotally coupled to the pivot assembly at the sixth joint 174. The sixth joint 174 establishes the pivot axis 176 (e.g., walking beam axis) of the pivot assembly. In the illustrated embodiment, the rotational axes of the wing wheels 72 are offset from one another along the longitudinal axis 34 due to the pivot assembly.

To transition the wing wheel assembly from the planting position to the illustrated headland position, the actuator 80 extends, thereby driving the second link 154 to rotate downwardly about the third joint 164. The downward rotation of the second link 154 drives the third link 156 to move downwardly due to the coupling between the second link 154 and the third link 156 at the fourth joint 166. In addition, the downward movement of the third link 156 drives the first link 152 to rotate downwardly about the first joint 160 due to the coupling between the third link 156 and the first link 152 at the second joint 162. As the second link 154 rotates downwardly, the fourth joint 166 moves toward the toolbar 18 along a curved path about the third joint 164. As a result, the third link 156 is driven to pivot about the second joint 162, such that the wing wheels are driven to move away from the toolbar 18 along the longitudinal axis 34. The movement of the wing wheels away from the toolbar 18 substantially offsets movement of the third link 156 toward the toolbar 18. Accordingly, the wing wheels follow a substantially straight path along the vertical axis 42. Thus, as the wing wheel linkage assembly 64 transitions from the planting position to the illustrated headland position, the wing wheels 72 remain at a relatively constant fore/aft position.

Further, the actuator 80 may drive the wing wheel linkage assembly 64 to transition from the illustrated headland position to the planting position. To transition the wing wheel assembly from the illustrated headland position the planting position, the actuator 80 contracts, thereby driving the second link 154 to rotate upwardly about the third joint 164. The upward rotation of the second link 154 drives the third link 156 to move upward due to the coupling between the second link 154 and the third link 156 at the fourth joint 166. In addition, the upward movement of the third link 156 drives the first link 152 to rotate upwardly about the first joint 160 due to the coupling between the third link 156 and the first link 152 at the second joint 162. As the second link 154 rotates upwardly, the fourth joint 166 moves away from the toolbar 18 along a curved path about the third joint 164. As a result, the third link 156 is driven to pivot about the second joint 162, such that the wing wheels are driven to move toward the toolbar 18 along the longitudinal axis 34. The movement of the wing wheels towards the toolbar 18 substantially offsets movement of the third link 156 away from the toolbar 18. Accordingly, the wing wheels follow a substantially straight path along the vertical axis 42. Thus, as the wing wheel linkage assembly 64 transitions from the illustrated headland position to the planting position, the wing wheels 72 remain at a relatively constant fore/aft position.

Due to the structure of the each wing wheel assembly, the wing wheels may be maintained in a longitudinal position longitudinally proximate to the pivot axis (e.g., axis of rotation) of the agricultural implement 10 while the wing wheels are in the planting position and in the headland position, thereby substantially aligning the wing wheels with the direction of motion of the toolbar as the agricultural implement turns. Accordingly, smearing of the soil by the wing wheels may be substantially reduced, thereby enhancing yield from seeds planted within the path of the wing wheels. While one wing wheel linkage assembly is described above, the other wing wheel linkage assemblies of the agricultural implement may have the same structure or a similar structure.

While the illustrated wing wheel linkage assembly is an asymmetric four bar linkage, in other embodiments, at least one wing wheel linkage assembly be another suitable type of linkage configured to substantially reduce movement of the wing wheels along the longitudinal axis as the wing wheels move between the planting position and the headland position. For example, in certain embodiments, at least one wing wheel linkage assembly may include a track coupled to the toolbar and a slider coupled to the wing wheels. The slider may be slidably engaged with the track, and the track may be oriented substantially along the vertical axis. Accordingly, the wing wheels may move substantially along the vertical axis between the planting position and the headland position. Furthermore, in certain embodiments, the wing wheel linkage assembly may include a tube coupled to the toolbar and a rod coupled to the wing wheels. The rod may be slidably engaged with the tube, and the tube may be orientated substantially along the vertical axis. Accordingly, the wing wheels may move substantially along the vertical axis between the planting position and the headland position.

While only certain features have been illustrated and described herein, many modifications and changes wheel occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural implement, comprising:
a main frame assembly;
a toolbar coupled to the main frame assembly;
a wing wheel linkage assembly coupled to the toolbar;
a wing wheel rotatably coupled to the wing wheel linkage assembly; and
an actuator coupled to the wing wheel linkage assembly and configured to drive the wing wheel linkage assembly to move the wing wheel substantially along a vertical axis between a planting position and a headland position;
wherein wing wheel linkage assembly is configured to control movement of the wing wheel along a longitudinal axis of the agricultural implement as the wing wheel moves between the planting position and the headland position, such that a rotational axis of the wing wheel is substantially aligned with an alignment line while the wing wheel is in the planting position and while the wing wheel is in the headland position; and
wherein the alignment line extends through a pivot axis of the agricultural implement and extends parallel to a lateral axis of the agricultural implement.

2. The agricultural implement of claim 1, wherein the wing wheel linkage assembly comprises a first link, a second link, a third link, and a toolbar link, the toolbar link is rigidly coupled to the toolbar, the first link is pivotally coupled to a toolbar link at a first joint and is pivotally coupled to the third link at a second joint, the second link is pivotally coupled to the toolbar link at a third joint and is pivotally coupled to the third link at a fourth joint, and the third link is coupled to the wing wheel.

3. The agricultural implement of claim 2, wherein a length of the first link is greater than a length of the second link.

4. The agricultural implement of claim 3, wherein the first link is positioned below the second link along the vertical axis.

5. The agricultural implement of claim 2, wherein the actuator is coupled to the second link at a sixth joint.

6. The agricultural implement of claim 1, comprising a pivot assembly coupled to the wing wheel and coupled to the third link move along the vertical.

7. The agricultural implement of claim 1, wherein the wing wheel remains forward of the toolbar relative to a direction of travel of the agricultural implement while the wing wheel is in the planting position and while the wing wheel is in the headland position.

8. An agricultural implement, comprising:
a main frame assembly;
a toolbar coupled to the main frame assembly, wherein the toolbar comprises a center section, a first wing section, and a second wing section, the first wing section is configured to rotate relative to the center section, the second wing section is configured to rotate relative to the center section;
a wing wheel linkage assembly coupled to the toolbar;
a wing wheel rotatably coupled to the wing wheel linkage assembly; and
an actuator coupled to the wing wheel linkage assembly and configured to drive the wing wheel linkage assembly to move the wing wheel substantially along a vertical axis between a planting position and a headland position;
wherein the wing wheel linkage assembly is coupled to the toolbar in the first wing section and is configured to control movement of the wing wheel along a longitudinal axis of the agricultural implement as the wing wheel moves between the planting position and the headland position, such that a rotational axis of the wing wheel is substantially aligned with an alignment line while the wing wheel is in the planting position and while the wing wheel is in the headland position; and
wherein the alignment line extends through a pivot axis of the agricultural implement and extends parallel to a lateral axis of the agricultural implement.

9. The agricultural implement of claim 8, wherein the wing wheel linkage assembly comprises a first link, a second link, a third link, and a toolbar link, the toolbar link is rigidly coupled to the toolbar, the first link is pivotally coupled to a toolbar link at a first joint and is pivotally coupled to the third link at a second joint, the second link is pivotally coupled to the toolbar link at a third joint and is pivotally coupled to the third link at a fourth joint, and the third link is coupled to the wing wheel.

10. The agricultural implement of claim 9, wherein a length of the first link is greater than a length of the second link.

11. The agricultural implement of claim 10, wherein the first link is positioned below the second link along the vertical axis.

12. The agricultural implement of claim 9, wherein the actuator is coupled to the second link at a sixth joint.

13. The agricultural implement of claim 9, comprising a pivot assembly coupled to the wing wheel and coupled to the third link.

14. The agricultural implement of claim 8, wherein the wing wheel remains forward of the toolbar relative to a direction of travel of the agricultural implement while the wing wheel is in the planting position and while the wing wheel is in the headland position.

15. The agricultural implement of claim 14, wherein an additional wing wheel linkage assembly is coupled to the toolbar in the second wing section.

16. An agricultural implement, comprising:
a main frame assembly;
a hitch assembly non-rotatably coupled to the main frame assembly and configured to rotatably couple the agricultural implement to a work vehicle;
a toolbar coupled to the main frame assembly;
a wing wheel linkage assembly coupled to the toolbar;
a wing wheel rotatably coupled to the wing wheel linkage assembly; and
an actuator coupled to the wing wheel linkage assembly and configured to drive the wing wheel linkage assembly to move the wing wheel substantially along a vertical axis between a planting position and a headland position;
wherein wing wheel linkage assembly is configured to control movement of the wing wheel along a longitudinal axis of the agricultural implement as the wing wheel moves between the planting position and the headland position, such that a rotational axis of the wing wheel is substantially aligned with an alignment line while the wing wheel is in the planting position and while the wing wheel is in the headland position;
wherein the wing wheel remains forward of the toolbar relative to a direction of travel of the agricultural implement while the wing wheel is in the planting position and while the wing wheel is in the headland position; and
wherein the alignment line extends through a pivot axis of the agricultural implement and extends parallel to a lateral axis of the agricultural implement.

17. The agricultural implement of claim 16, wherein the wing wheel linkage assembly comprises a first link, a second link, a third link, and a toolbar link, the toolbar link is rigidly coupled to the toolbar, the first link is pivotally coupled to a toolbar link at a first joint and is pivotally coupled to the third link at a second joint, the second link is pivotally coupled to the toolbar link at a third joint and is pivotally coupled to the third link at a fourth joint, and the third link is coupled to the wing wheel.

18. The agricultural implement of claim 17, wherein the first link is positioned below the second link along the vertical axis.

19. The agricultural implement of claim 18, wherein the first link and the second link rotates in a same direction when the wing wheel linkage assembly changes configurations, wherein the same direction is a clockwise or counterclockwise direction relative.

20. The agricultural implement of claim 17, wherein the actuator is coupled to the second link at a sixth joint.
